(19) United States
(12) Patent Application Publication
(10) Pub. No.: US 2026/0239175 A1
(43) Pub. Date: Aug. 13, 2026

(54) MULTI-UE CONTROL-REGION CHANGE

(71) Applicant: QUALCOMM Incorporated, San Diego, CA (US)

(72) Inventors: Gabi SARKIS, San Diego, CA (US); Mostafa KHOSHNEVISAN, San Diego, CA (US); Morteza SOLTANI, San Diego, CA (US); Weimin DUAN, San Diego, CA (US)

(21) Appl. No.: 19/053,391

(22) Filed: Feb. 13, 2025

(51) Int. Cl. H04W 48/10; H04L 5/00

(52) U.S. Cl. CPC H04W 48/10; H04L 5/005

(57) ABSTRACT

An apparatus for wireless communication at a user equipment (UE), may include at least one memory, and at least one processor coupled to the at least one memory. Based at least in part on information stored in the at least one memory, the at least one processor is configured to receive, from a network node, a message common to multiple UEs including the UE for changing a control region, wherein the message indicates a change to the control region that applies to one or more subsequent control transmission occasions, and monitor for control transmissions in accordance with the change to the control region indicated in the message.

### TECHNICAL FIELD

The present disclosure relates generally to communication systems, and more particularly, to wireless communication including control signaling.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of later telecommunication technologies may be based on aspects of 5G NR. There exists a need for further improvements in 5G NR and future telecommunication technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus for wireless communication at a user equipment (UE), may include at least one memory, and at least one processor coupled to the at least one memory. Based at least in part on information stored in the at least one memory, the at least one processor is configured to receive, from a network node, a message common to multiple UEs including the UE for changing a control region, where the message indicates a change to the control region that applies to one or more subsequent control transmission occasions. The at least one processor is further configured to monitor for control transmissions in accordance with the change to the control region indicated in the message.

In an aspect of the disclosure, a method, a computer-readable medium, and an apparatus are provided. The apparatus for wireless communication at a network node, may include at least one memory, and at least one processor coupled to the at least one memory. Based at least in part on information stored in the at least one memory, the at least one processor is configured to transmit a message that is common to multiple UEs, where the message indicates a change to a control region that applies to one or more subsequent control transmission occasion. The at least one processor is further configured to transmit a control transmission in accordance with the change to the control region indicated in the message.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example slot structure including a control region, in accordance with various aspects of the present disclosure.

FIG. 5 illustrates an example time and frequency diagram showing multiple bandwidth parts (BWPs) and a Control Resource Set (CORESET) for each BWP.

FIG. 6 shows diagrams illustrating examples of transmitting control region with UE-specific configuration and cell-specific configuration.

FIG. 7 shows diagrams illustrating examples of multi-UE messages indicating a change in the control region, which may be broadcast or groupcast, in accordance with various aspects of the present disclosure.

FIG. 8 shows diagrams illustrating examples of a groupcast multi-UE message indicating a change in the control region for multiple UEs, in accordance with various aspects of the present disclosure.

FIGS. 9A and 9B are diagrams illustrating examples of control region applying to one or more control transmissions, in accordance with various aspects of the present disclosure.

FIG. 10 is a diagram illustrating an example of updating the duration of the control region, in accordance with various aspects of the present disclosure.

FIG. 11 is a diagram illustrating an example of updating the bandwidth of the control region, in accordance with various aspects of the present disclosure.

FIG. 12 shows a diagram illustrating a message that indicates a change to the control region while excluding one or more control regions, in accordance with various aspects of the present disclosure.

FIG. 13 is a call flow diagram illustrating example control region update, in accordance with various aspects of the present disclosure.

FIGS. 14A and 14B are flowcharts of a method at a UE for updating the control region, in accordance with various aspects of the present disclosure.

FIG. 15 is a flowchart of a method at a network node for updating the control region, in accordance with various aspects of the present disclosure.

FIG. 16 is a diagram illustrating an example of a hardware implementation for an example apparatus and/or network entity.

FIG. 17 is a diagram illustrating an example of a hardware implementation for an example network entity.

### DETAILED DESCRIPTION

In wireless communication, the control region is a set of resources (e.g., time and frequency resources) that a base station may use to convey control information to a user equipment (UE). For example, the control region may correspond to the time and frequency resources in which a base station may transmit a physical downlink control channel (PDCCH) transmission to a UE. For example, in a downlink (DL) control region, the base station (e.g., eNB in LTE, gNB in NR, which may be referred to by other names in connection with other technologies) may transmit control information (e.g., in a PDCCH transmission) to the UE. The control information enables UEs to process and decode data transmissions and manage uplink transmissions effectively. The UE monitors the resources of the control region to receive the control information. Thus, the control region enables the UE to know when to monitor for such control information from the network. The use of a control region enables efficient communication and resource management in wireless communication systems.

In LTE, a control format indicator (CFI), transmitted via the physical control format indicator channel (PCFICH), specifies the number of orthogonal frequency-division multiplexing (OFDM) symbols allocated to a control region in a particular subframe. The CFI was based on fixed values, e.g., of 1, 2, or 3 symbols per subframe. For example, a value of 1 indicates that 1 symbol of the particular subframe will be used for control. A value of 2 indicates that 2 symbols of the particular subframe will be used for control. A value of 3 indicates that 3 symbols of the particular subframe will be used for control. The CFI applied uniformly to all UEs within the cell (e.g., served by the cell). The configuration is updated for every subframe (e.g., the CFI was sent for each subframe and indicated the control region for a single subframe). The CFI provided a consistent indication, but involved a rigid allocation of resources that applied for each UE in the cell. As well, the system incurs overhead because the CFI is transmitted in every subframe, regardless of network conditions or the number of active UEs, leading to added resource usage. Second, the configuration lacks adaptability, as the control region configuration applies uniformly to all UEs, without the ability to customize for individual UEs or varying traffic demands.

5G NR introduces a more flexible mechanism, the Control Resource Set (CORESET), that includes a semi-static configuration of resources (e.g. time and frequency resources) that may be used for control transmissions. In some aspects, a CORESET may be considered to be a control region. CORESET parameters, including size and location, are semi-statically configured and can vary across UEs or groups of UEs. For example, the CORESET may be configured in RRC signaling to the UE. One or more CORESETs may be configured for a cell, and may be applicable to each UE in the cell. One or more CORESETs may be configured individually for a particular UE. This configuration of CORESET resources provides added flexibility over the PCFICH-based approach in which a CFI is transmitted in each subframe to indicate the control region that applies to each UE served by the cell. The use of CORESETs enables a configurable duration for the UE to monitor for control transmissions, e.g., allowing the control region to span 1, 2, 3, or more symbols per slot, depending on deployment needs. The location of the control region can be set semi-statically within a slot or frame, offering flexibility for different network scenarios. CORESET also supports customizability, enabling different UEs or groups of UEs to monitor different CORESETs based on their assigned search spaces. A change to the CORESET configuration may be indicated in RRC signaling, which updates CORESET parameters for specific UEs or the entire cell or by bandwidth part (BWP) switching. As an example, one or more CORESETs may be configured for a particular BWP. If the UE switches to the BWP, the UE monitors the CORESET(s) configured for that BWP. For example, different BWPs may be associated with different CORESETs. As another example of switching, search space set group (SSSG) switching may adjust the resources UEs monitor for control information.

By RRC configuring the frequency-domain and time-domain resources allocated for control signaling, CORESET offers greater adaptability and efficiency compared to CFI. For example, the use of a CORESET allows tailored configurations for individual UEs or groups, reduces overhead by minimizing the control region size for inactive UEs or optimizing configurations for specific bandwidth parts, and supports scalability through dynamic bandwidth allocation and efficient resource management.

Aspects presented herein provide added efficiency beyond the flexibility offered by CORESET. For example, updating CORESETs includes unicast (e.g. RRC) signaling, where individual messages are sent to UEs, resulting in delays and inefficiencies, especially in high-density scenarios.

Various aspects relate generally to wireless communication. Some aspects more specifically relate to wireless communication schemes enabling a multi-UE message for signaling control region changes. Aspects presented herein enable a multi-UE message to indicate a change in a control region (e.g., a change to modify the control region and/or to switch to a different control region), where the change applies to subsequent control transmissions. The change may be referred to as a sticky change, e.g., which may apply for a present and future occasions of the control region. For example, the change may be applicable for a configured, or signaled, duration.

In some examples, the UE may receive from a network node a message common to multiple UEs including the UE for changing a control region. The message may indicate a change to the control region that applies to one or more subsequent control transmission occasions. The UE may then monitor for control transmissions in accordance with the change to the control region indicated in the message. The control region may correspond to time and frequency resources for the UE to monitor for the control transmissions.

In some aspects, the change to the control region may be a modification that applies to one or more active control regions for the UE.

In some aspects, the UE may modify a duration of the control region for the one or more subsequent control transmission occasions based on the change to the control region indicated in the message. For example, the message may indicate an update to the duration of the control region as an absolute duration. Additionally or alternatively, the message may indicate an update to the duration of the control region as a difference relative to a current duration of the control region.

In some aspects, the UE may modify a current bandwidth of the control region to an updated bandwidth of the control region in accordance with the change in the control region indicated in the message. For example, the change indicated to the control region may include an indication to switch to a different control region or a different control region configuration. In some aspects, the change to the control region may include an updated bandwidth indicated in the message by one or more of a control region identifier (ID) or an index that is different than the control region ID. In some aspects, the indication to switch may indicate at least one of a first switch from a current control region to an associated control region that is associated with the current control region, or a second switch from a first configuration associated with the control region to a second configuration associated with the control region.

In some aspects, the message may be indicated a broadcast transmission that includes at least one of a downlink control information (DCI) transmission, a medium access control-control element (MAC-CE) in a physical downlink shared channel (PDSCH) transmission, or a system information block (SIB) transmission. Additionally or alternatively, the message may be indicated in a groupcast transmission to the multiple UEs including the UE, that includes at least one of a group common downlink control information (DCI) transmission, or a medium access control-control element (MAC-CE) in a multi-cast physical downlink shared channel (PDSCH) transmission.

In some aspects, the message may indicate a radio network temporary identifier (RNTI) associated with control region changes, wherein the RNTI is common to a group of UEs, including the UE.

In some aspects, the message may include one or more fields common to a group of UEs, including the UE, wherein the one or more fields indicate the change to the control region. Additionally or alternatively, the message may include a DCI having a plurality of fields, where a subset of one or more fields indicate the change to the control region for the UE and other fields of the plurality of fields are for other UEs of the multiple UEs. In some aspects, the UE may determine the subset of one or more fields for the UE based on a configuration or a radio network temporary identifier (RNTI).

In some aspects, the UE may exclude a set of one or more control regions from the change to the control region indicated in the message, where the set of one or more control regions is based on least on one of a rule that defines the one or more excluded control regions, a configuration of one or more excluded control regions obtained prior to receiving the message for changing the control region, or an indication of one or more excluded control regions in the message that indicates the change. In some aspects, monitoring for the control transmissions may involve monitoring for the control transmissions in accordance with the change to the control region until a timer expires. Additionally or alternatively, monitoring for the control transmissions may involve monitoring for the control transmissions in accordance with the change to the control region until reception of a next message that changes the control region.

Particular aspects of the subject matter described in this disclosure can be implemented to realize one or more of the following potential advantages. In some examples, the techniques disclosed herein provide a solution by introducing a method where a network node transmits a single indication of a control region change to a group of UEs via a multi-UE message. This message can be broadcast or groupcast and may include one or more of DCI, MAC-CE, or SIBs, thus reduce or eliminating the need for per-UE signaling. The technique enables efficient resource management by applying the change across multiple control transmissions, e.g., in a sticky manner. For example, the change may be indicated in a sticky configuration, corresponding to a modification that applies in an ongoing manner to one or more occasions of the active control regions for the UE (e.g., until the next indication is received or a timer expires, among other examples). Additionally, the techniques support dynamic and flexible configurations, including modifications to the control region duration and bandwidth, switching between alternative control regions, and group RNTIs that allow UEs to decode only the relevant data blocks in a multi-UE message. By reducing signaling overhead and providing flexible and scalable solutions for control region management, the technical solutions disclosed herein enhance network efficiency and responsiveness, addressing challenges in wireless communication systems.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

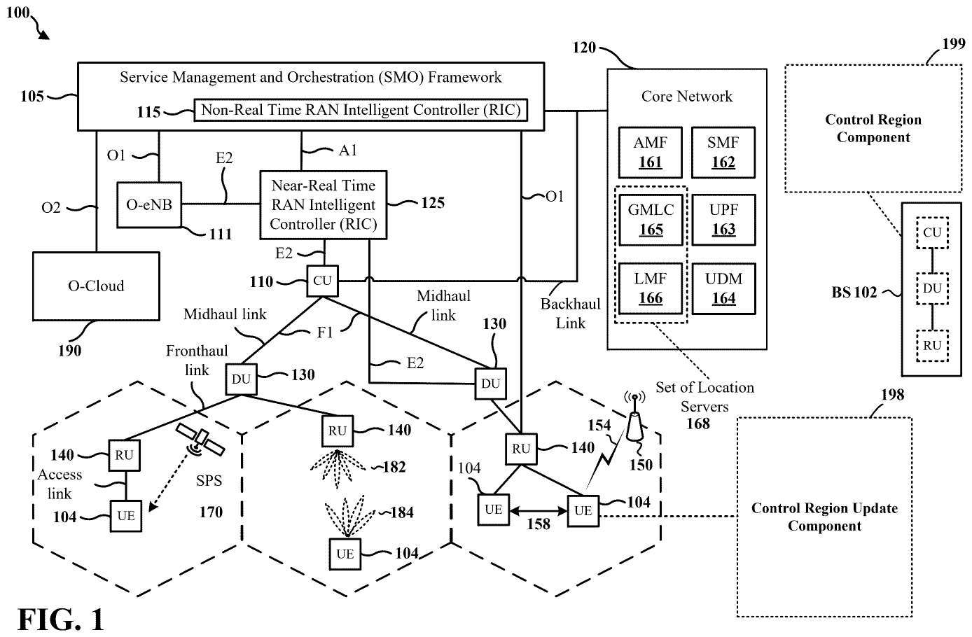

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a control region update component 198 that may be configured to change the control region. For example, the control region update component 198 may be configured to receive, from a network node, a message common to multiple UEs including the UE for changing a control region, where the message indicates a change to the control region that applies to one or more subsequent control transmission occasions, and to monitor for control transmissions in accordance with the change to the control region indicated in the message. For example, the In certain aspects, the base station 102 may have a control region component 199 that may be configured to change the control region. For example, the control region component 199 may be configured to transmit a message that is common to multiple UEs, where the message indicates a change to a control region that applies to one or more subsequent control transmission occasion, and transmit a control transmission in accordance with the change to the control region indicated in the message.

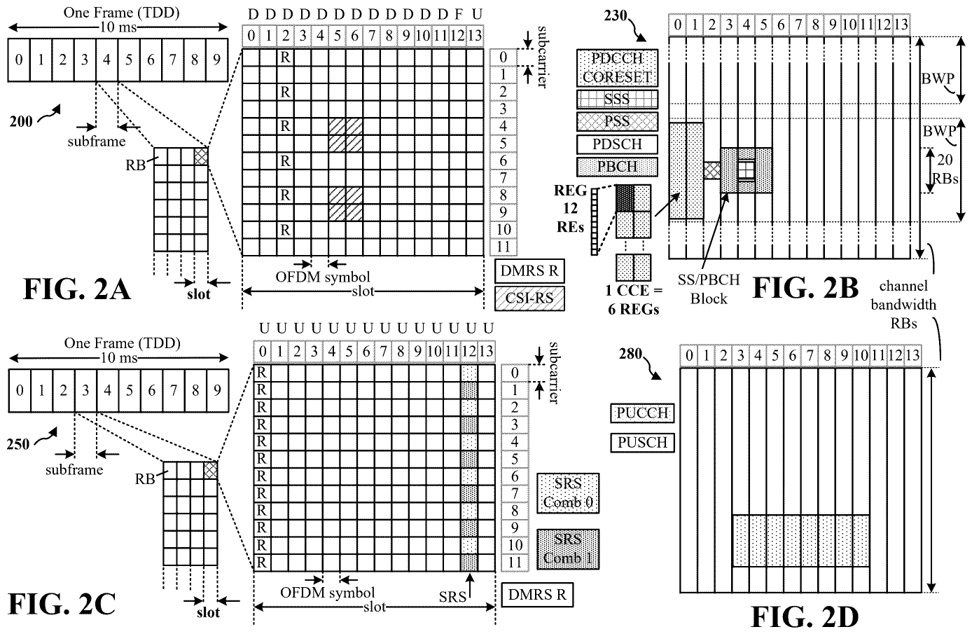

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

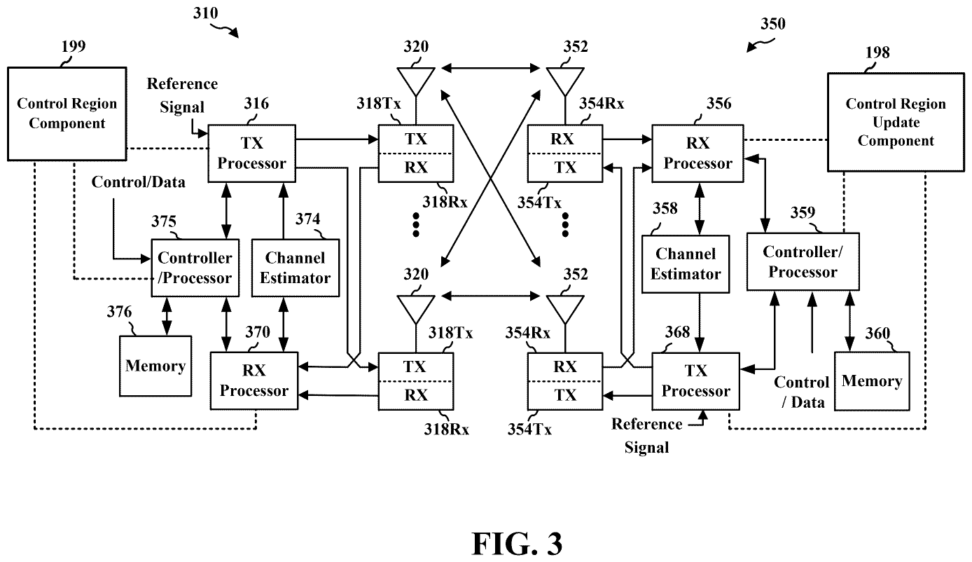

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the control region update component 198 of FIG. 1.

At least one of the TX processor 316, the RX processor 370, and the controller/processor 375 may be configured to perform aspects in connection with the control region component 199 of FIG. 1.

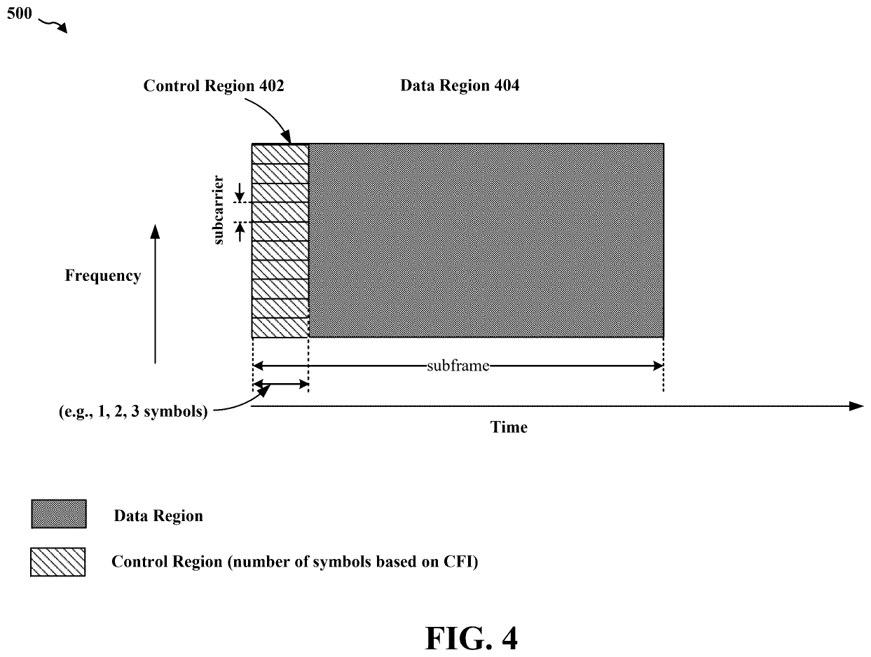

As stated above, in wireless communication, the control region is a set of resources (e.g., time and frequency resources) that a base station may use to convey control information to a user equipment (UE). For example, the control region may correspond to the time and frequency resources in which a base station may transmit a physical downlink control channel (PDCCH) transmission to a UE. For example, for DL control region, the control information transmitted from the base station (e.g., eNB in LTE, gNB in NR, which may be referred to by other names in connection with other technologies) may transmit control information (e.g., in a PDCCH transmission) to the UE. The UE monitors the resources of the control region to receive the control information. Thus, the control region enables the UE to know when to monitor for such control information from the network. The use of a control region enables efficient communication and resource management in wireless communication systems. For example, FIG. 4 is a diagram illustrating an example of resources that include a control region 402, in accordance with various aspects of the present disclosure. Other regions may include a data region 404, for example. The DL control region 402 may span one or a few OFDM symbols and occupies a set of physical resources in time and frequency. Within the DL control region, the base station may transmit a PDCCH transmission, e.g., to deliver DCI to the UE. Therefore, the UE monitors the control region to attempt to receive any PDCCH transmissions. As stated above, a RE is a unit representing one subcarrier in frequency over a single symbol in time. In some examples, certain REs of a downlink-centric slot may carry downlink reference signals, e.g., for channel estimation at the UE. The duration of the control region, e.g., 602, in each subframe is indicated by a CFI that is transmitted for each subframe, e.g., in a PCFICH transmission. The CFI indicates the duration of the control region that is applicable in common to each UE served by the cell. For example, a CFI value of 1 indicates that 1 symbol of the particular subframe will be used for control. A CFI value of 2 indicates that 2 symbols of the particular subframe will be used for control. A CFI value of 3 indicates that 3 symbols of the particular subframe will be used for control. The CFI appliea uniformly to all UEs within the cell (e.g., served by the cell). As the PCFICH is transmitted in every subframe, and the UE decodes the CFI before being able to receive the PDCCH, the use of the CFI impacts the processing timeline at the UE. For example, the UE takes time to decode the CFI before attempting to decode a PDCCH transmission, which slows the decoding of the PDCCH. The CFI involves a consistent use of overhead to transmit the CFI each subframe, e.g., even if there is no change in traffic.

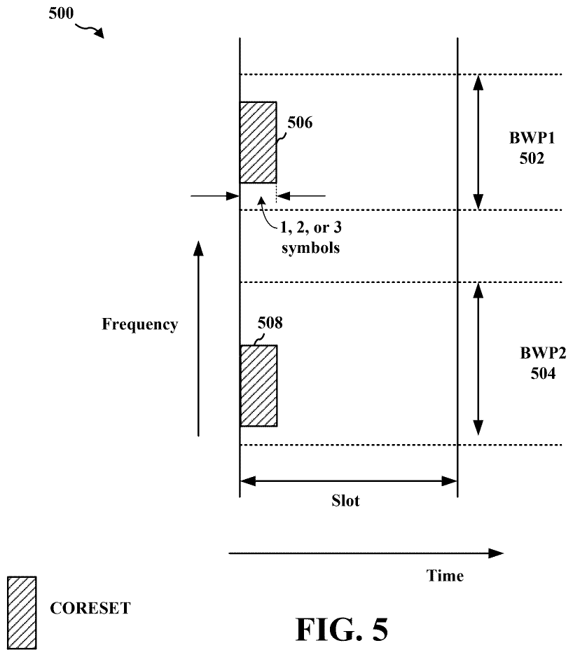

Compared with CFI, the use of a CORESET to configure semi-static control regions provides some added flexibility and signaling efficiency. A CORESET corresponds to a configurable set of physical resources in time and frequency that a UE uses to monitor for PDCCH/DCI. Each CORESET comprises one or more RBs in the frequency domain and one or more symbols in the time domain. The frequency resources of a CORESET may be contiguous or non-contiguous. As an example, a CORESET might comprise multiple RBs in the frequency domain and 1, 2, or 3 contiguous symbols in the time domain. The REs within a CORESET may be organized in RE groups (REGs). An REG may correspond to one RB (e.g., 12 REs) during one OFDM symbol. A control channel element (CCE) may include REGs, e.g., 6 REGs. The REGs within a CORESET may be numbered in increasing order in a time-first manner, starting with 0 for the first OFDM symbol and the lowest-numbered resource block in the CORESET. A UE can be configured with multiple CORESETs, each CORESET being associated with one CCE-to-REG mapping. The CCE-to-REG mapping may be interleaved or non-interleaved. In some aspects, one or more CORESET(s) may be configured for a particular BWP. For example, FIG. 5 illustrates an example time and frequency diagram 500 showing multiple bandwidth parts (BWPs) including BWP1 502 and BWP2 504, and a CORESET (e.g., 506 and 508) for each BWP. A PDCCH may be carried by 1, 2, 4, 8, or 16 CCEs, e.g., to accommodate different sizes of DCI, different coding rates, etc.

Parameters for a CORESET may be provided by higher layer parameters, e.g., via an RRC parameter. Among others, such CORESET parameters may indicate a duration parameter indicating a length in time, a frequency domain resource parameter, a parameter indicating whether a CCE-to-REG mapping is interleaved or non-interleaved, and/or a REG bundle size comprising a number of REGs, an aggregation level indicating an amount of CCEs allocated for PDCCH, etc. Each CORESET may be identified using a CORESET ID. A common CORESET that is not UE specific, e.g., being configured via a MIB, may be indicated as CORESET 0. CORESET 0 may correspond to an initial BWP, a default BWP, etc. CORESETs configured in dedicated signaling for the UE may be identified beginning with CORESET 1, CORESET 2, and so forth.

A UE may be configured to blindly monitor, e.g., attempt to blindly decode, a number of PDCCH candidates of different DCI formats and different aggregation levels. The blind decoding may involve additional processing at a UE but may provide additional flexibility in scheduling and handling of different DCI formats.

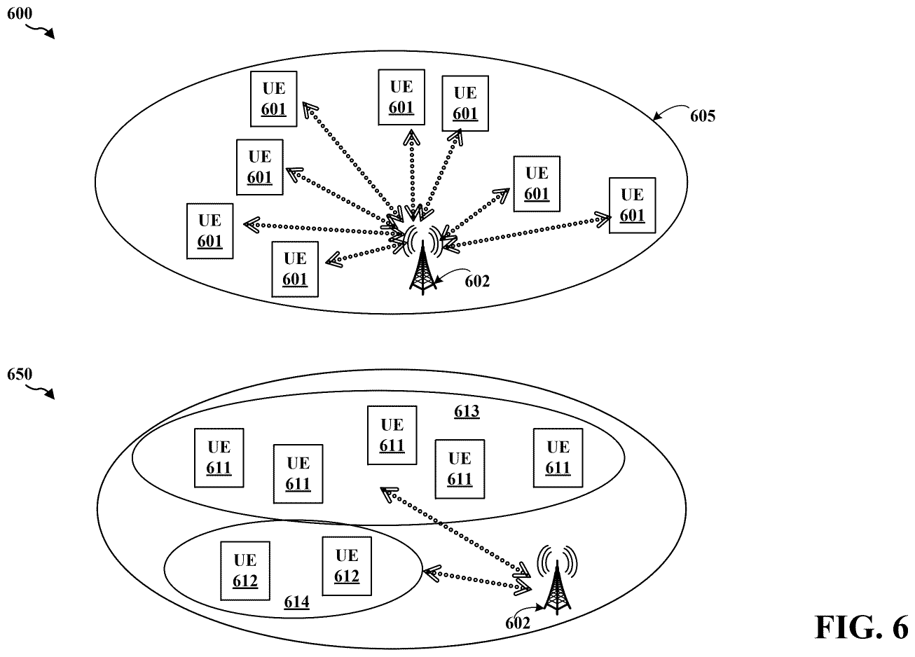

A configuration, or reconfiguration of CORSET parameters may be UE specific (e.g., in RRC signaling directed to a particular UE) or cell-specific (such as in system information or a SIB, among other examples). For example, FIG. 6 includes diagrams 600 and 650, which illustrate examples of transmitting control region with UE-specific configuration and cell-specific configuration. In diagram 600, a network node 602 transmits control region transmissions with UE-specific configurations to individual UEs 601 within cell 605, where each UE 601 receives a control region transmission configured for that UE. Alternatively, as shown in diagram 650, the network node 602 transmits control region transmissions with a cell-specific configuration, where a first configuration applies to all UEs 611 within cell 613, and a different configuration applies to all UEs 612 within cell 614.

Additionally or alternatively, the control region may also be changed through BWP switching, which dynamically switches UEs between configured BWPs, each associated with different CORESETs. For example, as shown in FIG. 5, control region 506 is configured for BWP1 502 and control region 508 is configured for BWP2 504. Therefore, switching from BWP1 502 to BWP2 504 may result in the UE switching from monitoring a control region 506 to monitoring control region 508.

The control region may also be changed through SSSG switching, which adjusts the resources that UEs monitor for control information, thereby switching the control region. As an example, the SSSG switch may be indicated in DCI. Although the SSSG switching does not directly switch the CORESET, the UE may monitor a CORESET indicated in a search space (SS) configuration. When all SSs that are associated with (or point to) a particular CORESET are switched, the UE will stop monitoring that CORESET and use a different CORESET based on the current SSs.

Although the use of CORESET allows for some added flexibility compared to CFI, updating or reconfiguring a CORESET can involve a large number of unicast messages, where individual messages are sent to UEs, resulting in delays and inefficiencies, especially in high-density scenarios. Although a cell-specific RRC configuration changing a cell-specific CORESET can be transmitted in a SIB, e.g., without the large number of unicast messages, the cell-specific CORESET has reduced flexibility for individual UEs.

Aspects provided herein enable more flexible changes to control regions while maintain low system resource overhead. In some examples, the techniques disclosed herein provide a solution by introducing a method where a network node transmits a single message (or single indication) of a control region change to a group of UEs via a multi-UE message. This message can be broadcast or groupcast and may include any of a DCI, a MAC-CE, or a SIB, thus reducing or even eliminating the need for per-UE signaling. The technique also enables efficient resource management by applying the change across multiple control transmissions or control region occasions (e.g., in a sticky configuration that applies to multiple occasions of the control region). Additionally, the technique supports dynamic and flexible configurations, including modifications to the control region duration, switching between alternative control regions, and group RNTIs that allow UEs to identify and decode the relevant data blocks in a multi-UE message (e.g., and avoid decoding portions intended for other UEs). By reducing signaling overhead and providing flexible and scalable solutions for control region management, the techniques disclosed herein enhance network efficiency and responsiveness.

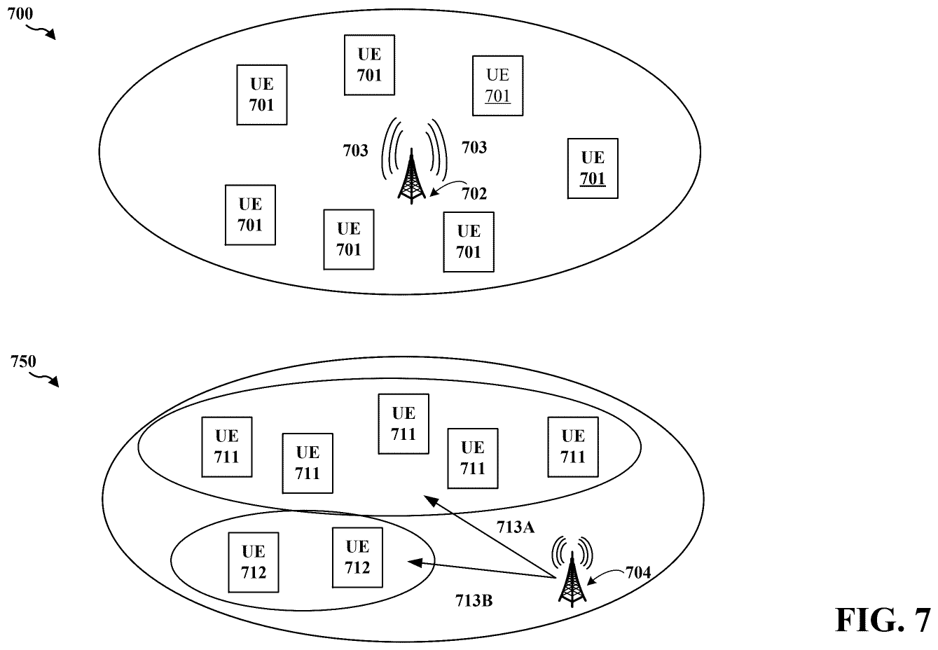

FIG. 7 shows diagrams 700 and 750 illustrating examples of multi-UE messages indicating a change in the control region, which may be broadcast or groupcast, in accordance with various aspects of the present disclosure. As discussed in detail below, the multi-UE message may indicate modifying the control region and/or switching to a different control region.

In some aspects, the multi-UE message may be a broadcast message. For example, as shown in diagram 700, a network node 702 may broadcast a multi-UE message 703 to UEs 701, indicating a change in the control region. In some aspects, the broadcast multi-UE message 703 may be indicated in a DCI format, a MAC-CE transmitted via a broadcast PDSCH, or a SIB. As an example, the indication may be in a field within a SIB, wherein the field is dedicated for control region changes. In some aspects, the SIB may be dedicated for control region changes.

In some aspects, the multi-UE message may also be a groupcast message. For example, as shown in diagram 750, a network node 704 may groupcast a multi-UE message 713A to a group of UEs 711. A different groupcast multi-UE message 713B may be configured for another group of UEs 712. The groupcast multi-UE message 713A or 713B may be indicated in a group common DCI format. Additionally or alternatively, the groupcast multi-UE message may be indicated via a MAC-CE transmitted in a multicast PDSCH.

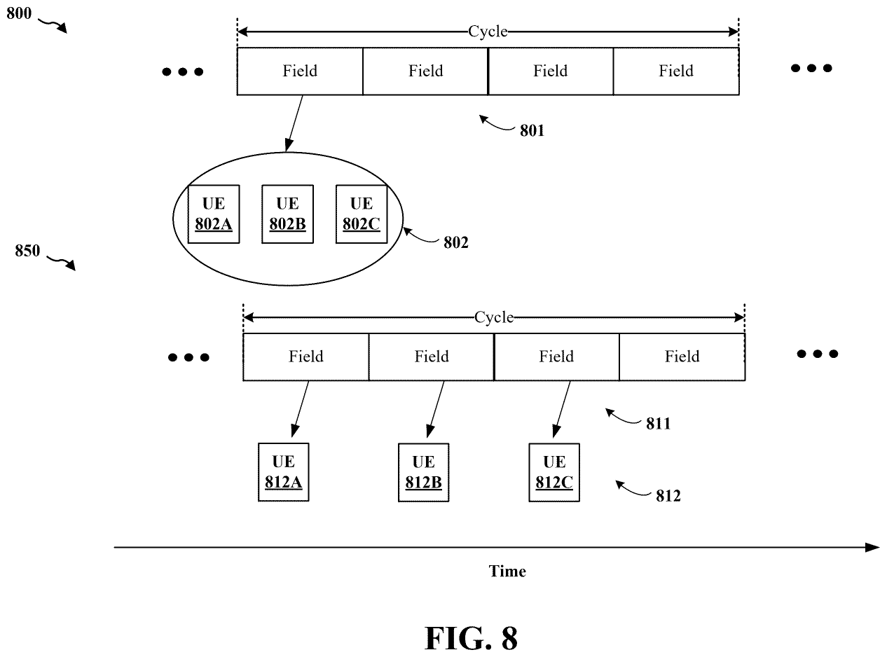

In situations where the multi-UE message is a groupcast message (e.g., the groupcast multi-UE message 713A or 713B), the group of UEs (e.g., UEs 701 and/or 711) may be assigned a RNTI to monitor for the control region change message. In some aspects, the DCI indicating the control region change may include a single set of fields that are applicable to all UEs monitoring the RNTI. Additionally or alternatively, the DCI may include multiple sets of fields, where each UE reads one of the sets applicable to it. For example, FIG. 8 shows diagrams 800 and 850, illustrating examples of a groupcast multi-UE message indicating a change in the control region for multiple UEs, in accordance with various aspects of the present disclosure.

The DCI, MAC-CE, broadcast/groupcast PDSCH, or SIB may indicate a timeline, or duration, for the applicability of the control region change. For example, rather than an RRC reconfiguration, the change may be a sticky change that applies for the indicated duration. After the indicated duration, the control region may revert to a prior control region or a default control region, among other examples.

As stated above, in some aspects, the DCI in the groupcast multi-UE message indicating a control-region change may include a single set of fields that apply to UEs monitoring a common RNTI. For example, as shown in diagram 800, a network node may transmit a groupcast multi-UE message 801 to a group of UEs 802, including UE 802A, UE 802B, and UE 802C. The groupcast multi-UE message 801 may contain one or more fields indicating a control-region change applicable to the group of UEs 802. The RNTI may be assigned to the group of UEs, and the UEs in the group may decode a control region change from the message if the message includes or is based on the assigned RNTI.

Additionally or alternatively, the DCI in the multi-UE message indicating a control-region change may include multiple sets of fields, where each UE receiving the message reads one or more fields configured for that specific UE. For example, as shown in diagram 850, a multi-UE message 811 may be transmitted for multiple UEs 812, including UE 812A, 812B, and 812C. The multi-UE message 811 includes a DCI with a plurality of fields, a subset (e.g., one or more) of which indicates the control region change for UE 812A. Other fields within the plurality of fields may correspond to other UEs, such as UEs 812B, 812C, and so on. In some aspects, UE 812A may determine the subset of fields applicable to it based on a configuration or a RNTI, such as through a modulo operation. For example, a single field of the multiple fields of the DCI may be based on, or include, the RNTI that is specific to a particular UE. The UE uses the RNTI to identify the field corresponding to the UE and obtain the corresponding change in the control region for the UE. In some aspects, the RNTI may be based on the C-RNTI for the UE.

It is noted that the number of fields and corresponding UEs shown in FIG. 8 are illustrative examples. Any suitable number of fields and corresponding UEs may apply.

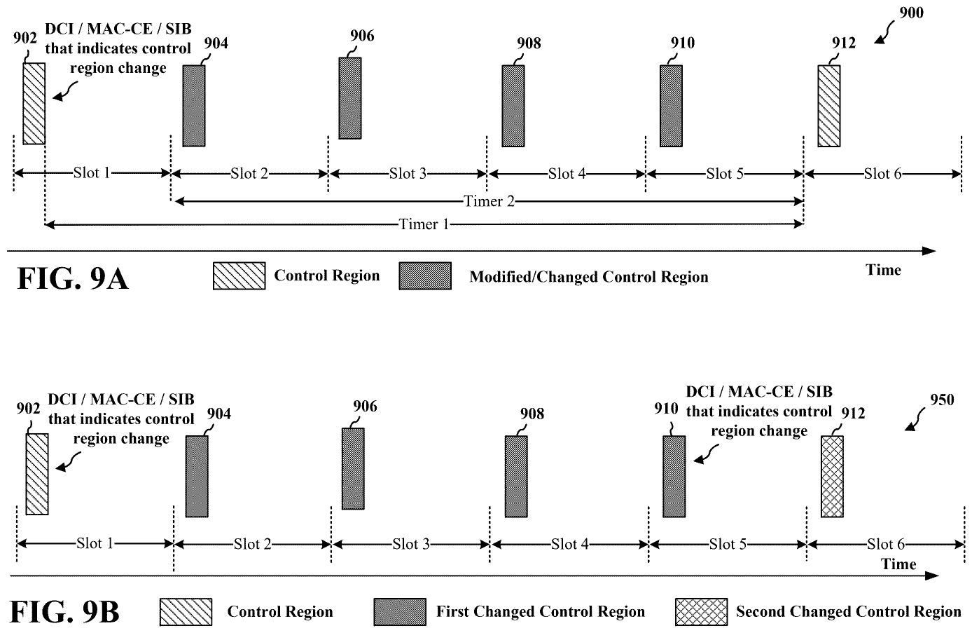

As stated above, the technique disclosed herein also enhances resource management efficiency by applying the change across multiple control transmissions. Specifically, the change may be indicated in a sticky configuration, corresponding to a modification that applies to one or more active control region occasions for the UE (e.g., across multiple subframes or multiple slots). For example, FIGS. 9A and 9B are diagrams 900 and 950 illustrating examples of control region applying to one or more control transmissions, in accordance with various aspects of the present disclosure.

In some aspects, the change to the control region indicated in a control signal (e.g., DCI, MAC-CE, and/or SIB) may apply to one or more subsequent control transmission occasions (or control region occasions) until a particular duration ends. In some aspects, the duration may be until a timer expires or until a next control region change is indicated. For example, as shown in diagram 900, the UE may receive a message indicating the change to the control region at 902. The UE may then monitor one or more subsequent control transmissions and one or more subsequent control region occasions (e.g., control regions at 904, 906, 908, and 910) in accordance with the indicated change until the timer expires. Thus, the indicated change may be referred to as a “sticky” change that applies to multiple slots, in contrast to the CFI that is indicated every subframe. As well, the indicated change may be associated with a duration, rather than a semi-static RRC configuration for a CORESET. In some aspects, the timer may start from 902 when the control signal indicating the change to the control region is received, such as timer 1. In such cases, the change to the control region may apply to the same slot where the control signal indicating the change is received (e.g., slot 1 after receiving the control signal). Additionally or alternatively, the timer may be applied starting from the next slot (e.g., slot 2) after the control signal indicating the change to the control region is received, such as timer 2.

In some aspects, the timer may correspond to an applicability timeline (e.g., the change may be applied after a certain number of slots), which may be specified, configured, or signaled in the message indicating the change to the control region. The applicability timeline may indicate a start and/or a stop of the application of the change to the control region. Additionally or alternatively, the timeline and/or the timer may be indicated in a separate message configured by the network node. In some aspects, the timer may be based on a defined duration, e.g., that is defined in a wireless standard rather than signaled to the UE.

In some aspects, the change to the control region may apply to one or more subsequent control transmissions until reception of a next message that changes the control region. For example, as shown in diagram 950, the UE may receive a message indicating the change to the control region at 902. The UE may then monitor for one or more subsequent control transmissions (e.g., control regions 904, 906, 908, and 910) in accordance with the indicated change until another message indicating the change to the control region at 912.

It is noted that the number of one or more subsequent control transmissions and the corresponding slots shown in FIGS. 9A and 9B are illustrative examples. Any suitable number of one or more subsequent control transmissions and corresponding slots may apply.

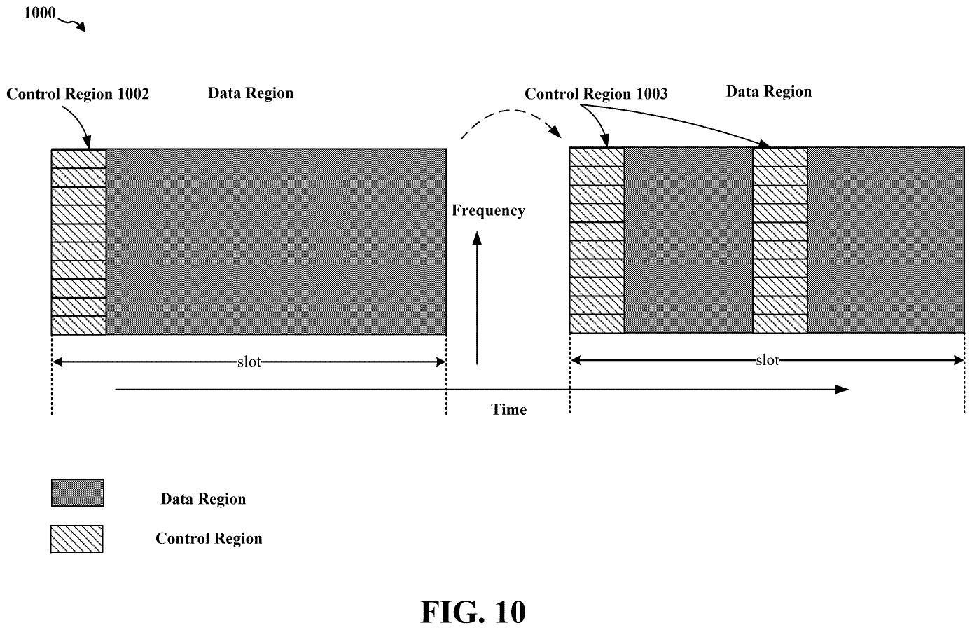

As discussed above, the change to the control region indicated in the multi-UE message may correspond to modifying the control region and/or switching to a different control region. According to the message (e.g., e.g., the broadcast message 703 in FIG. 7, the groupcast multi-UE message 713A or 713B in FIG. 7, or the groupcast multi-UE messages 801 and/or 811 in FIG. 8), the UE may modify the duration of the control region for one or more subsequent control transmission occasions. For example, FIG. 10 is a diagram illustrating an example of updating the duration of the control region, in accordance with various aspects of the present disclosure.

As shown in diagram 1000, the UE may initially monitor for control transmissions in accordance with a first control region 1002, which corresponds to a first duration. Upon receiving the message (e.g., e.g., the broadcast message 703 in FIG. 7, the groupcast multi-UE message 713A or 713B in FIG. 7, or the groupcast multi-UE messages 801 and/or 811 in FIG. 8), the UE may monitor for control transmissions in accordance with a second control region 1003, corresponding to a second duration.

In some aspects, the updated duration of the control region may be indicated in the message as an absolute duration for the control region or a relative change to a current control region duration. In one aspect, the absolute duration of the second control region 1003 may be directly specified in the message when updating from control region 1002, e.g., indicating an absolute number of symbols for the control region. Alternatively, the message may indicate the update as a difference relative to the current duration of the control region. As an example, the indication may indicate that the duration of the control is to be increased or decreased by one or more symbols. For instance, the difference between the first control region 1002 and the second control region 1003 may be included in the message. In some aspects, the indication may reference or indicate an alternative duration for the control region, e.g., without signaling a particular number of symbols. For example, an alternative duration may be previously configured or defined for the control region. The message may include an indication that indicates the alternative, and the UE may apply the corresponding duration associated with the alternative.

In some aspects, the change indicated in the control region may include an instruction to switch to a different control region or a different configuration for a control region. The indication to switch may specify a transition from the current control region to an associated control region. For example, the message may indicate a switch from control region 1002 to control region 1003 when updating configurations.

Additionally or alternatively, the switch may occur between a first configuration and a second configuration associated with the control region. For example, the message may indicate a switch from the configuration of control region 1002 to that of control region 1003.

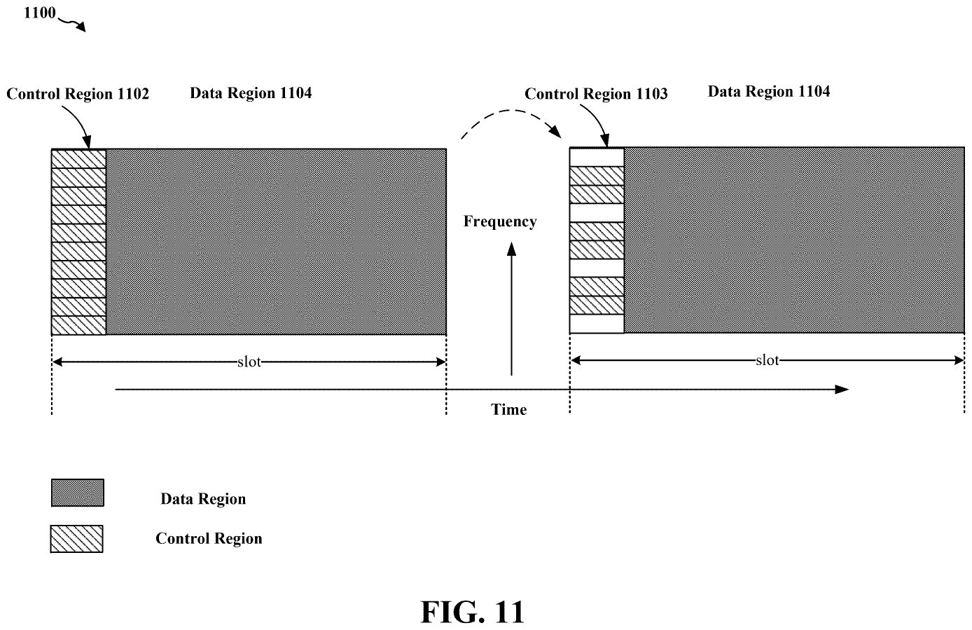

As stated above, the change to the control region indicated in the message may also correspond to updating the bandwidth of the control region. For example, FIG. 11 is a diagram illustrating an example of updating the bandwidth of the control region, in accordance with various aspects of the present disclosure.

As shown in diagram 1100, the UE may initially monitor for control transmissions in a first control region 1102 with a first frequency bandwidth. Other regions may include, e.g., a data region 1104. Upon receiving the message (e.g., the broadcast message 703 in FIG. 7, the groupcast multi-UE message 713A or 713B in FIG. 7, or the groupcast multi-UE messages 801 and/or 811 in FIG. 8), the UE may update its monitoring to a second control region 1103, which corresponds to a second frequency bandwidth.

In some aspects, the change may include an indication to switch to a different control region or configuration. The updated bandwidth may be indicated in the message by one or more identifiers, such as a control region ID or an index separate from the control region ID.

In some aspects, the indication to switch may refer to a transition from a current control region to an associated control region. For example, the message may indicate a switch from control region 1102 to control region 1103 when updating the bandwidth.

Additionally or alternatively, the message may indicate a switch from a first configuration to a second configuration associated with the control region. For example, the message may specify a switch from the configuration of control region 1102 to that of control region 1103.

In some aspects, as applicable to both changes in bandwidth and duration discussed with respect to FIGS. 10 and 11, the message may indicate the change to the control region based on a control region ID that identifies the control region to switch to. For example, the ID may correspond to the control region configured for each UE (e.g., a CORESET ID).

Additionally or alternatively, the ID may correspond to an index of the control region to switch to, configured separately from the control region ID. This may avoid conflicts where two UEs are configured with different control regions that share the same ID. For example, control region 1 may have an ID of 1 and an “index” of 3. If the signaling indicates “index 3,” the UE may use control region 1.

In some aspects, the ID may also correspond to a switch to an alternative control region. The configuration of the control region may include either an alternative configuration or the ID of another control region to use as an alternative. For example, control region 1 may have a duration of three symbols and lists control region 2 as its alternative. Control region 2 may have a duration of one symbol. If control region 1 is active, the indication to use the alternative control region will switch the UE to control region 2. Otherwise, the UE will monitor control region 1. For another example, control region 1 may have a default duration of three symbols and an alternative duration of one symbol. The UE will monitor control region 1 with one symbol if the signaling indicates the use of the alternative configuration. Otherwise, the UE will monitor control region 1 with three symbols.

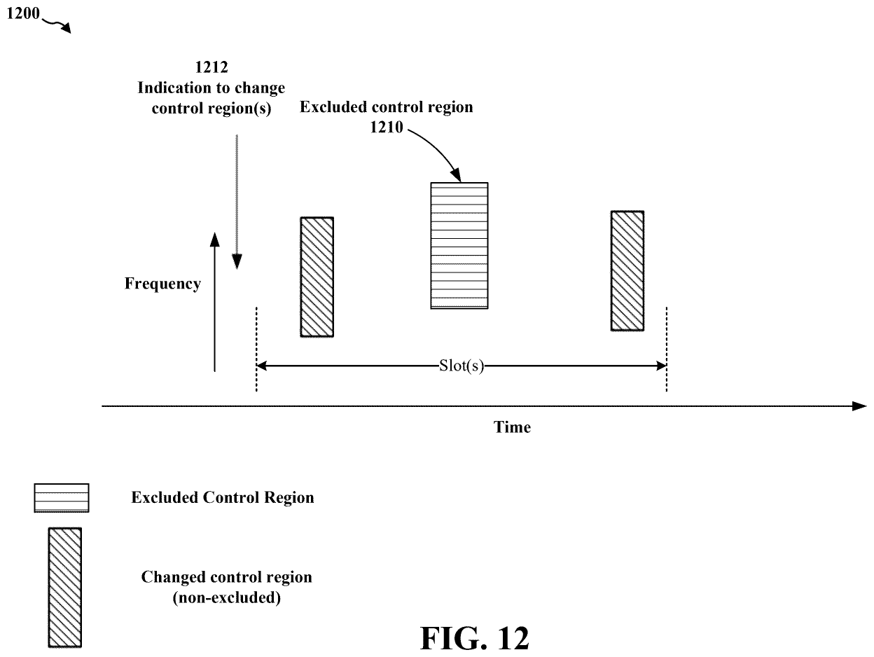

In some aspects, the change to the control region indicated in the multi-UE message may indicate for the UE to exclude a set of one or more control regions from the change. For example, FIG. 12 shows a diagram 1200 illustrating a message, at 1212, that indicates a change to one or more control region(s) while excluding one or more control regions 1210, in accordance with various aspects of the present disclosure. For example, the UE may switch to monitoring the changed control regions following the indication 1212, yet may continue to monitor the excluded control region without change. The message (e.g., the broadcast message 703 in FIG. 7, the groupcast multi-UE message 713A or 713B in FIG. 7, or the groupcast multi-UE messages 801 and/or 811 in FIG. 8) may specify a set of control regions 1210 to be excluded from the change.

In some aspects, the excluded control regions may be based on a rule that defines the one or more excluded control regions, such as a CORESET that is defined in a wireless communication standard to be excluded from the change. For example, if defined in the wireless standard, the one or more excluded control regions would be known by the UE and the network node, e.g., without added signaling or configuration. As an example, a wireless standard may indicate that CORESET 0, or another CORESET, is to be excluded from such changes. Additionally, or alternatively, one or more excluded control regions may be based on a configuration obtained prior to receiving the message. For example, the UE may receive an RRC configuration from the network indicating one or more control regions (e.g., CORESETs) to be excluded from such changes. Additionally or alternatively, the message itself may include an indication (e.g., such as an explicit indication) of one or more control regions to be excluded from the change. In some aspects, exclusions from the change may be based on a list of excluded control regions. The list of one or more excluded control regions may be defined (e.g., defined in a wireless standard), signaled in a configuration of a list of excluded control regions, or indicated in the message itself. In some aspects, the control region's configuration may include an indicator indicating whether the control region is to be excluded from changes.

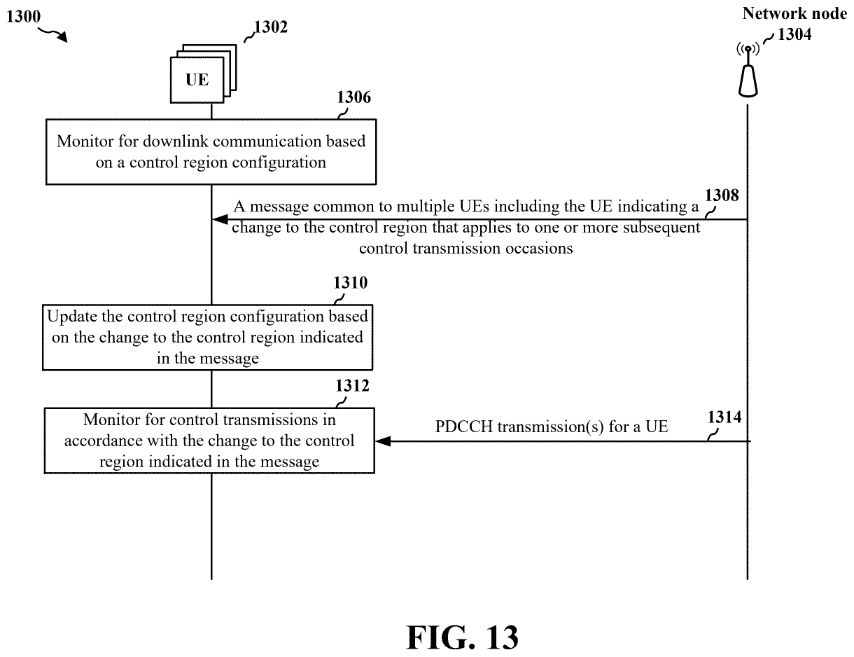

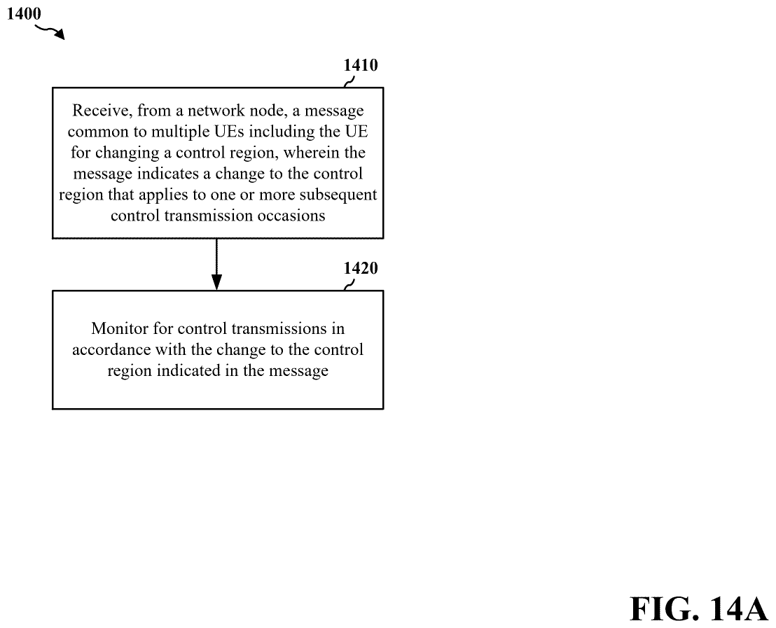

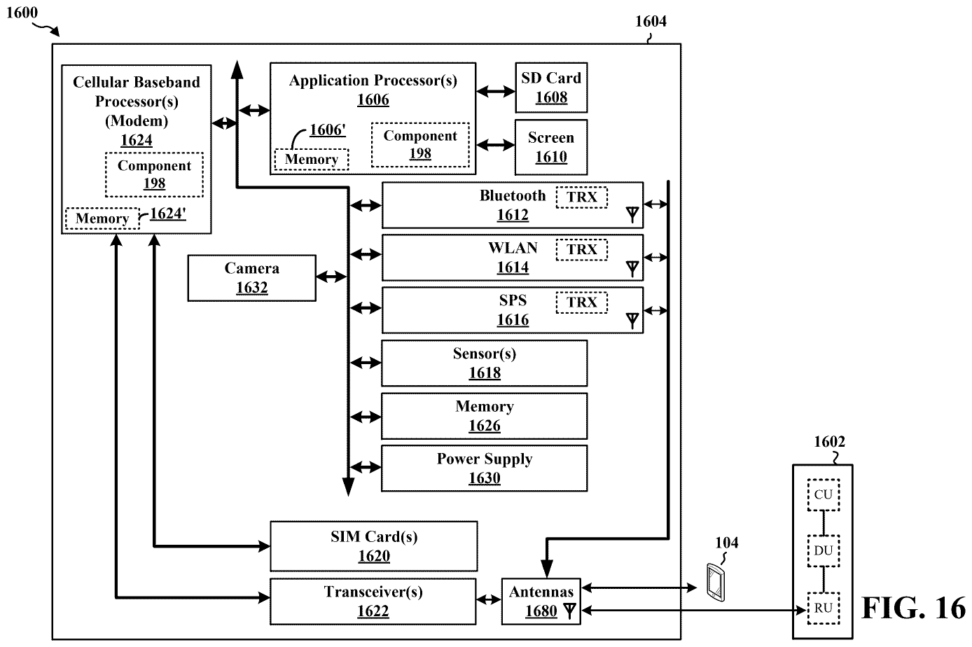

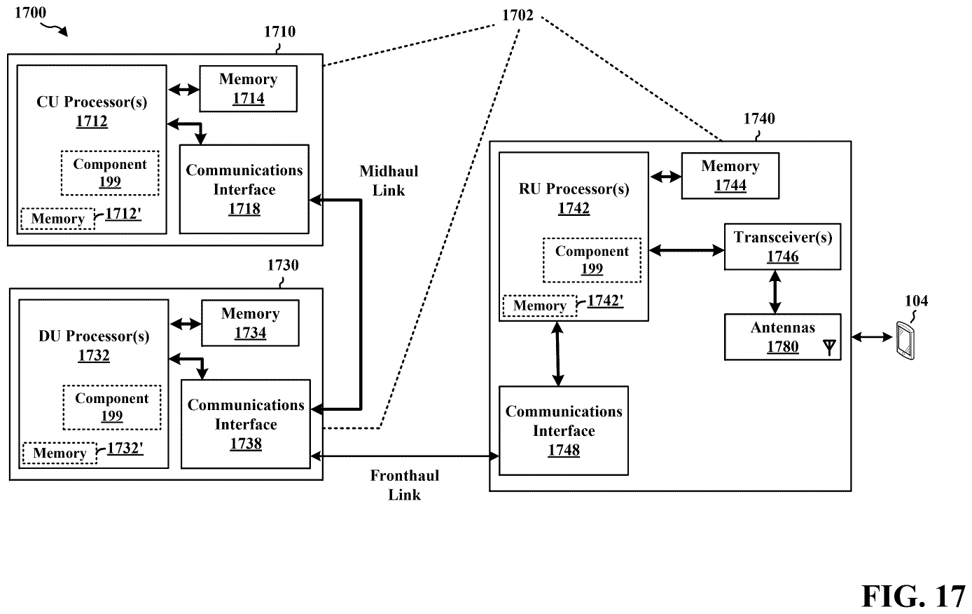

FIG. 13 is a call flow diagram 1300 illustrating example control region update, in accordance with various aspects of the present disclosure. The control region update may be performed between a UE 1302 and a network node 1304. In some aspects, the UE 1302 may correspond to the UE 104 in FIG. 1, the UE 701, 711, and/or 712 in FIG. 7, the UE 802 and/or 812 in FIG. 8, or the apparatus 1604 in the hardware implementation of FIG. 16. The network node 1304 may correspond to the base station 102 in aggregation and/or by one or more components (e.g., such as a CU 110, a DU 130, and/or an RU 140) in FIG. 1, the base station 310 in aggregation and/or by one or more components in FIG. 3, or the network entity 1702 in the hardware implementation of FIG. 17.

Starting at 1306, the UE 1302 may monitor for DL communication based on a control region configuration. For example, the UE 1302 may monitor for PDCCH/DCI based on a set of configured physical resources in time and frequency.

At 1308, the network node 1304 may transmit a message common to multiple UEs including the UE for changing a control region. In some aspects, the message may indicate a change to the control region that applies to one or more subsequent control transmission occasions. For example, the message may be a groupcast multi-UE message (e.g., the groupcast multi-UE message 713A or 713B in FIG. 7, or the groupcast multi-UE messages 801 and/or 811 in FIG. 8) and/or the message may be a broadcast multi-UE message 703 in FIG. 7.

In some aspects, as discussed with respect to FIGS. 9A and 9B, the message may apply to one or more subsequent control transmission occasions, until a timer expires, as illustrated in FIG. 9A. In some aspects, an applicability timeline for starting and/or stopping the application of the change to the control region may be based on a timer (e.g., the change may be applied after a certain number of slots and/or for a certain number of slots), which may be specified, configured, or signaled in the message indicating the change to the control region. In some aspects, one or more aspects of the timeline for applying the change may be defined rather than signaled. Additionally or alternatively, the timeline and/or the timer may be indicated in a separate message configured by the network node.

Additionally or alternatively, the message may apply to one or more subsequent control transmission occasions, until reception of a next message that changes the control region, as illustrated in FIG. 9B.

At 1310, the UE 1302 may update the control region configuration based on the change to the control region indicated in the message. In some aspects, in situations where the multi-UE message is a groupcast message (e.g., the groupcast multi-UE message 713A or 713B), the group of UEs (e.g., UEs 701 and/or 711) including the UE 1302 may be assigned a RNTI to monitor for the control region change message. The UE 1302 may determine the subset of one or more fields for the UE 1302 based on a configuration or a RNTI as discussed with respect to FIG. 8.

In some aspects, according to the message (e.g., the broadcast message 703 in FIG. 7, the groupcast multi-UE message 713A or 713B in FIG. 7, or the groupcast multi-UE messages 801 and/or 811 in FIG. 8), the UE 1302 may modify the duration of the control region for one or more subsequent control transmission occasions, as discussed with respect to FIG. 10. Additionally or alternatively, according to the message, the UE 1302 may update the bandwidth of the control region, as discussed with respect to FIG. 11.

At 1312, the UE 1302 may monitor for control transmissions in accordance with the change to the control region indicated in the message. At 1314, the network node 1304 may transmit PDCCH transmission(s) for the UE 1302 in accordance with the change to the control region indicated in the message.

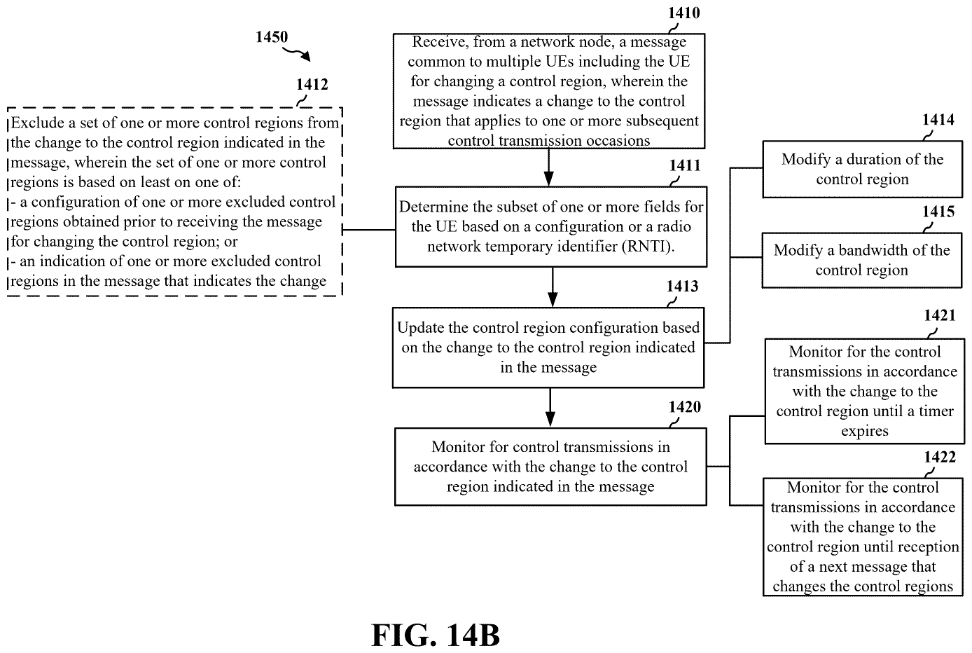

FIG. 14A is a flow chart 1400 of a method at a UE for updating the control region, in accordance with various aspects of the present disclosure. The UE may correspond to the UE 104 in FIG. 1, the UE 350 in FIG. 3, the UE 701, 711, and/or 712 in FIG. 7, the UE 802 and/or 812 in FIG. 8, the UE 1302 in FIG. 13, or the apparatus 1604 in the hardware implementation of FIG. 16. The method may help to provide added flexibility in resources for control regions while maintaining efficiencies in control signaling overhead.

At 1410, the UE may receive, from a network node, a message common to multiple UEs including the UE for changing a control region, where the message indicates a change to the control region that applies to one or more subsequent control transmission occasions. For example, the message may be a groupcast multi-UE message (e.g., the groupcast multi-UE message 713A or 713B in FIG. 7, or the groupcast multi-UE messages 801 and/or 811 in FIG. 8) and/or the message may be a broadcast multi-UE message 703 in FIG. 7. The reception of the message that indicates control region changes for multiple UEs can help to avoid signaling overhead by avoiding separate messages to each of the UEs. FIG. 13 illustrates an example of a UE 1302 that receives a message, at 1308.

In some aspects, as discussed with respect to FIGS. 9A and 9B, the message may apply to one or more subsequent control transmission occasions, until a timer expires, as illustrated in FIG. 9A. In some aspects, the change may be referred to as “sticky” as it applies for multiple control transmission occasions. In some aspects, the timer may correspond to an applicability timeline (e.g., the change may be applied after a certain number of slots), which may be specified, configured, or signaled in the message indicating the change to the control region. Additionally or alternatively, the timeline and/or the timer may be indicated in a separate message configured by the network node.

Additionally or alternatively, the message may apply to one or more subsequent control transmission occasions, until reception of a next message that changes the control region, as illustrated in FIG. 9B. In some aspects, 1410 may be performed by the control region update component 198 in FIG. 16.

At 1420, the UE may monitor for control transmissions in accordance with the change to the control region indicated in the message. For example, the UE may update the control region configuration based on the change to the control region indicated in the message and may monitor for control transmissions in accordance with the change to the control region indicated in the message. As stated above, in some aspects, according to the message (e.g., the broadcast message 703 in FIG. 7, the groupcast multi-UE message 713A or 713B in FIG. 7, or the groupcast multi-UE messages 801 and/or 811 in FIG. 8), the UE may modify the duration of the control region for one or more subsequent control transmission occasions, as discussed with respect to FIG. 10. Additionally or alternatively, according to the message, the UE may update the bandwidth of the control region, as discussed with respect to FIG. 11. FIG. 13 illustrates an example of the UE 1302 monitoring for the control transmission, at 1312, based on the update received at 1308. In some aspects, 1420 may be performed by the control region update component 198 in FIG. 16.

FIG. 14B is a flow chart 1450 of a method at a UE for updating the control region, in accordance with various aspects of the present disclosure. The UE may correspond to the UE 104 in FIG. 1, the UE 350 in FIG. 3, the UE 701, 711, and/or 712 in FIG. 7, the UE 802 and/or 812 in FIG. 8, the UE 1302 in FIG. 13, or the apparatus 1604 in the hardware implementation of FIG. 16. Some aspects of FIG. 14B may be similar to the aspects of FIG. 14A and are shown with the same reference number. The method may help to provide added flexibility in resources for control regions while maintaining efficiencies in control signaling overhead.

At 1410, the UE may receive, from a network node, a message common to multiple UEs including the UE for changing a control region, where the message indicates a change to the control region that applies to one or more subsequent control transmission occasions. For example, the message may be a groupcast multi-UE message (e.g., the groupcast multi-UE message 713A or 713B in FIG. 7, or the groupcast multi-UE messages 801 and/or 811 in FIG. 8) and/or the message may be a broadcast multi-UE message 703 in FIG. 7. FIG. 13 illustrates an example of the UE 1302 receiving an example message at 1308.

In some aspects, as discussed with respect to FIGS. 9A and 9B, the message may apply to one or more subsequent control transmission occasions, until a timer expires, as illustrated in FIG. 9A. In some aspects, the timer may correspond to an applicability timeline (e.g., the change may be applied after a certain number of slots), which may be specified, configured, or signaled in the message indicating the change to the control region. Additionally or alternatively, the timeline and/or the timer may be indicated in a separate message configured by the network node.

Additionally or alternatively, the message may apply to one or more subsequent control transmission occasions, until reception of a next message that changes the control region, as illustrated in FIG. 9B. In some aspects, 1410 may be performed by the control region update component 198 in FIG. 16.

At 1411, the UE may determine the subset of one or more fields for the UE based on a configuration or a RNTI. For example, in situations where the multi-UE message is a groupcast message (e.g., the groupcast multi-UE message 713A or 713B in FIG. 7), the group of UEs (e.g., UEs 701 and/or 711 in FIG. 7) may be assigned a RNTI to monitor for the control region change message. The UE may determine the subset of one or more fields for the UE based on a configuration or a RNTI as discussed with respect to FIG. 8. In some aspects, 1411 may be performed by the control region update component 198 in FIG. 16.

At 1412, according to the subset of one or more fields for the UE, discussed with respect to FIG. 12, a set of one or more control regions may be excluded from the change to the control region indicated in the message. In some aspects, the set of excluded control regions may be determined based on a rule that defines (e.g., in a wireless standard) the one or more excluded control regions. Additionally, or alternatively, the set of excluded control regions may be determined based on a configuration (e.g., such as an RRC configuration) of one or more excluded control regions obtained prior to receiving the message. Additionally or alternatively, the excluded control regions may be determined based on an indication in the message (e.g., such as an explicit indication) that specifies the control regions to be excluded from the change. In some aspects, 1412 may be performed by the control region update component 198 in FIG. 16.

At 1413, the UE may update the control region configuration based on the change to the control region indicated in the message. In some aspects, in situations where the multi-UE message is a groupcast message (e.g., the groupcast multi-UE message 713A or 713B in FIG. 7, or the groupcast multi-UE message 801 or 811 in FIG. 8), the group of UEs (e.g., UEs 701 and/or 711 in FIG. 7, or UEs 802 or 812 in FIG. 8) including the UE may be assigned a RNTI to monitor for the control region change message. The UE may determine the subset of one or more fields for the UE based on a configuration or a RNTI as discussed with respect to FIG. 8.

In some aspects, according to the message (e.g., the broadcast message 703 in FIG. 7, the groupcast multi-UE message 713A or 713B in FIG. 7, or the groupcast multi-UE messages 801 and/or 811 in FIG. 8), at 1414, the UE may modify the duration of the control region for one or more subsequent control transmission occasions, as discussed with respect to FIG. 10. Additionally or alternatively, according to the message, at 1415, the UE may update the bandwidth of the control region, as discussed with respect to FIG. 11. In some aspects, 1413, 1414, and/or 1415 may be performed by the control region update component 198 in FIG. 16.

At 1420, the UE may monitor for control transmissions in accordance with the change to the control region indicated in the message. FIG. 13 illustrates an example of the UE 1302 monitoring for the control transmission, at 1312, based on the update received at 1308. In some aspects, 1420 may be performed by the control region update component 198 in FIG. 16.

In some aspects, at 1421, the UE may monitor for the control transmissions in accordance with the change to the control region until a timer expires. For example, as discussed with respect to FIG. 9A, the message may apply to one or more subsequent control transmission occasions, until a timer expires. In some aspects, the timer may correspond to an applicability timeline (e.g., the change may be applied after a certain number of slots), which may be specified, configured, or signaled in the message indicating the change to the control region. Additionally or alternatively, the timeline and/or the timer may be indicated in a separate message configured by the network node. In some aspects, 1421 may be performed by the control region update component 198 in FIG. 16.

Additionally or alternatively, at 1422, the UE may monitor for the control transmissions in accordance with the change to the control region until reception of a next message that changes the control regions. In some aspects, 1422 may be performed by the control region update component 198 in FIG. 16.

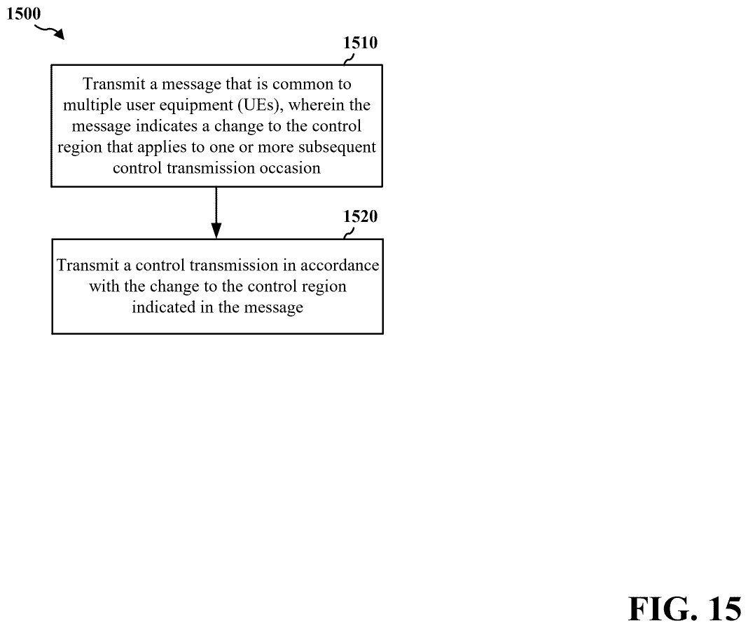

FIG. 15 is a flowchart 1500 of a method at a network node for updating the control region, in accordance with various aspects of the present disclosure. The network node may correspond to the base station (e.g., 102) in aggregation and/or by one or more components of a base station (e.g., such as any of base station 102, 310; network node 602, 702, 1304; a CU 110; a DU 130; an RU 140and/or the network entity 1702). The method may help to provide added flexibility in resources for control regions while maintaining efficiencies in control signaling overhead.

At 1510, the network node may transmit a message that is common to multiple user equipment (UEs), wherein the message indicates a change to the control region that applies to one or more subsequent control transmission occasion. By transmitting the multi-UE message, the network node may help to reduce, or avoid increases to, signaling overhead. In some aspects, 1510 may be performed by the control region component 199 in FIGS. 17 and/or 18. FIG. 13 illustrates an example transmission of a message to multiple UEs at 1308.

In some aspects, the control region may correspond to time and frequency resources for a UE of the multiple UEs to monitor for the control transmissions. In some aspects, the change to the control region is a modification that applies to one or more active control regions for the UE. In some aspects, the network not may configure the UE to modify a duration of the control region for the one or more subsequent control transmission occasions based on the change to the control region indicated in the message. In some aspects, the message may indicate an update to the duration of the control region as an absolute duration. In some aspects, the change to the control region includes an updated bandwidth indicated in the message by one or more of a control region identifier (ID) or an index that is different than the control region ID.

At 1520, the network node may transmit a control transmission in accordance with the change to the control region indicated in the message. For example, the network node may transmit a PDCCH transmission to a UE within a control region based on the change to the control region indicated at 1510. FIG. 13 illustrates an example of a network node transmitting a PDCCH transmission to a UE, at 1314, after indicating a control region change at 1308. In some aspects, 1520 may be performed by the control region component 199 in FIGS. 17 and/or 18.

FIG. 16 is a diagram 1600 illustrating an example of a hardware implementation for an apparatus 1604. The apparatus 1604 may be a UE, a component of a UE, or may implement UE functionality. In some aspects, the apparatus1604 may include at least one cellular baseband processor 1624 (also referred to as a modem) coupled to one or more transceivers 1622 (e.g., cellular RF transceiver). The cellular baseband processor(s) 1624 may include at least one on-chip memory 1624′. In some aspects, the apparatus 1604 may further include one or more subscriber identity modules (SIM) cards 1620 and at least one application processor 1606 coupled to a secure digital (SD) card 1608 and a screen 1610. The application processor(s) 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) 1624 communicates through the transceiver(s) 1622 via one or more antennas 1680 with the UE 104 and/or with an RU associated with a network entity 1602. The cellular baseband processor(s) 1624 and the application processor(s) 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor(s) 1624 and the application processor(s) 1606 are each responsible for general processing, including the execution of software stored on the computer-readable medium/memory. The software, when executed by the cellular baseband processor(s) 1624/application processor(s) 1606, causes the cellular baseband processor(s) 1624/application processor(s) 1606 to perform the various functions described supra. The cellular baseband processor(s) 1624 and the application processor(s) 1606 are configured to perform the various functions described supra based at least in part of the information stored in the memory. That is, the cellular baseband processor(s) 1624 and the application processor(s) 1606 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1624/application processor(s) 1606 when executing software. The cellular baseband processor(s) 1624/application processor(s) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) 1624 and/or the application processor(s) 1606, and in another configuration, the apparatus 1604 may be the entire UE (e.g., see UE 350 of FIG. 3) and include the additional modules of the apparatus 1604.

As discussed supra, the control region update component 198 may be configured to receive, from a network node, a message common to multiple UEs including the UE for changing a control region, where the message indicates a change to the control region that applies to one or more subsequent control transmission occasions. The control region update component 198 may also be configured to monitor for control transmissions in accordance with the change to the control region indicated in the message. The control region update component 198 may be further configured to perform any of the aspects described in connection with the flowcharts in FIG. 14A or 14B and/or any of the aspects performed by the UE in the communication flow of FIG. 13. The control region update component 198 may be within the cellular baseband processor(s) 1624, the application processor(s) 1606, or both the cellular baseband processor(s) 1624 and the application processor(s) 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) 1624 and/or the application processor(s) 1606, may include means for receiving, from a network node, a message common to multiple UEs including the UE for changing a control region, where the message indicates a change to the control region that applies to one or more subsequent control transmission occasions; means for monitoring for control transmissions in accordance with the change to the control region indicated in the message; means for modifying a duration of the control region for the one or more subsequent control transmission occasions based on the change to the control region indicated in the message; means for modifying a current bandwidth of the control region to an updated bandwidth of the control region in accordance with the change in the control region indicated in the message; the means for determining the subset of one or more fields for the UE based on a configuration or a radio network temporary identifier (RNTI); means for excluding a set of one or more control regions from the change to the control region indicated in the message, wherein the set of one or more control regions is based on least on one of: a rule that defines the one or more excluded control regions; a configuration of one or more excluded control regions obtained prior to receiving the message for changing the control region; or an indication of one or more excluded control regions in the message that indicates the change; means for monitoring for the control transmissions in accordance with the change to the control region until a timer expires; and means for monitoring for the control transmissions in accordance with the change to the control region until reception of a next message that changes the control region. The apparatus 1604 may further include means for performing any of the aspects described in connection with the flowcharts in FIG. 14A or 14B and/or any of the aspects performed by the UE in the communication flow of FIG. 13. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor 1712. The CU processor(s) 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include at least one DU processor 1732. The DU processor(s) 1732 may include on-chip memory 1732′. In some aspects, the DU 1730 may further include additional memory modules 1734 and a communications interface 1738. The DU 1730 communicates with the RU 1740 through a fronthaul link. The RU 1740 may include at least one RU processor 1742. The RU processor(s) 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the control region component 199 may be configured to transmit a message that is common to multiple UEs, where the message indicates a change to the control region that applies to one or more subsequent control transmission occasion, and transmit a control transmission in accordance with the change to the control region indicated in the message. The control region component 199 and/or the network entity 1702 may be further configured to perform any of the aspects described in connection with the flowchart in FIG. 15 and/or any of the aspects performed by the network node in the communication flow of FIG. 13. The control region component 199 may be within one or more processors of one or more of the CU 1710, DU 1730, and the RU 1740. The control region component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In one configuration, the network entity 1702 may include means for transmitting a message that is common to multiple user equipment (UEs), wherein the message indicates a change to the control region that applies to one or more subsequent control transmission occasion; means for transmitting a control transmission in accordance with the change to the control region indicated in the message; means for configuring the UE to modify a duration of the control region for the one or more subsequent control transmission occasions based on the change to the control region indicated in the message; and means for configuring the UE to modify a current bandwidth of the control region to an updated bandwidth of the control region in accordance with the change in the control region indicated in the message. The network entity 1702 may further include means for performing any of the aspects described in connection with the flowchart in FIG. 15 and/or any of the aspects performed by the network node in the communication flow of FIG. 13. The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

Aspects presented herein provide added efficiency for updating control regions, e.g., beyond the flexibility offered by CORESET. For example, updating control regions often utilizes unicast signaling, where individual messages are sent to UEs, resulting in delays and inefficiencies, especially in high-density scenarios.

The subject matter described in this disclosure can be implemented to realize one or more of the following potential advantages. In some examples, the techniques disclosed herein provide a solution by introducing a method where a network node transmits a single indication of a control region change to a group of UEs via a multi-UE message. This message can be broadcast or groupcast and may include downlink control information (DCI), medium access control-control elements (MAC-CE), or system information blocks (SIBs), thus reduce or eliminating the need for per-UE signaling. The technique enables efficient resource management by applying the change across multiple control transmissions. For example, the change may be indicated in a sticky configuration, corresponding to a modification that applies to one or more active control regions (e.g., multiple occasions of a control region) for the UE. Additionally, the technique supports dynamic and flexible configurations, including modifications to the control region duration, switching between alternative control regions, and group RNTIs that allow UEs to decode the relevant data blocks in a multi-UE message. By reducing signaling overhead and providing flexible and scalable solutions for control region management, the technical solutions disclosed herein enhance network efficiency and responsiveness, addressing key challenges in wireless communication systems.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S S F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication of a user equipment (UE), comprising: receiving, from a network node, a message common to multiple UEs including the UE for changing a control region, wherein the message indicates a change to the control region that applies to one or more subsequent control transmission occasions; and monitoring for control transmissions in accordance with the change to the control region indicated in the message.

Aspect 2 is a method of Aspect 1, wherein the control region corresponds to time and frequency resources for the UE to monitor for the control transmissions.

Aspect 3 is a method of aspect 1 or 2, wherein the change to the control region is a modification that applies to one or more active control regions for the UE.

Aspect 4 is a method of any of aspects 1 to 3, further comprising: modifying a duration of the control region for the one or more subsequent control transmission occasions based on the change to the control region indicated in the message.

Aspect 5 is a method of any of aspects 1 to 4, wherein the message indicates an update to the duration of the control region as an absolute duration.

Aspect 6 is a method of any of aspects 1 to 4, wherein the message indicates an update to the duration of the control region as a difference relative to a current duration of the control region.

Aspect 7 is a method of any of aspects 1 to 6, further comprising: modifying a current bandwidth of the control region to an updated bandwidth of the control region in accordance with the change in the control region indicated in the message.

Aspect 8 is a method of any of aspects 1 to 7, wherein the change indicated to the control region includes an indication to switch to a different control region or a different control region configuration.

Aspect 9 is a method of any of aspects 1 to 8, wherein the change to the control region includes an updated bandwidth indicated in the message by one or more of a control region identifier (ID) or an index that is different than the control region ID.

Aspect 10 is a method of any of aspects 1 to 9, wherein the indication to switch indicates at least one of: a first switch from a current control region to an associated control region that is associated with the current control region, or a second switch from a first configuration associated with the control region to a second configuration associated with the control region.

Aspect 11 is a method of any of aspects 1 to 10, wherein the message is indicated a broadcast transmission, wherein the message comprises at least one of: a downlink control information (DCI) transmission; a medium access control-control element (MAC-CE) in a physical downlink shared channel (PDSCH) transmission; or a system information block (SIB) transmission.

Aspect 12 is a method of any of aspects 1 to 10, wherein the message is indicated in a groupcast transmission to the multiple UEs including the UE, wherein the message comprises at least one of: a group common downlink control information (DCI) transmission; or a medium access control-control element (MAC-CE) in a multi-cast physical downlink shared channel (PDSCH) transmission.

Aspect 13 is a method of any of aspects 1 to 12, wherein the message indicates a radio network temporary identifier (RNTI) associated with control region changes, wherein the RNTI is common to a group of UEs, including the UE.

Aspect 14 is a method of any of aspects 1 to 13, wherein the message comprises one or more fields common to a group of UEs, including the UE, wherein the one or more fields indicate the change to the control region.

Aspect 15 is a method of any of aspects 1 to 13, wherein the message comprises a DCI having a plurality of fields, wherein a subset of one or more fields indicates the change to the control region for the UE and other fields of the plurality of fields are for other UEs of the multiple UEs.

Aspect 16 is a method of any of aspects 1 to 15, further comprising: determining the subset of one or more fields for the UE based on a configuration or a radio network temporary identifier (RNTI).

Aspect 17 is a method of any of aspects 1 to 16, further comprising: excluding a set of one or more control regions from the change to the control region indicated in the message, wherein the set of one or more control regions is based on least on one of: a rule that defines the one or more excluded control regions; a configuration of one or more excluded control regions obtained prior to receiving the message for changing the control region; or an indication of one or more excluded control regions in the message that indicates the change.

Aspect 18 is a method of any of aspects 1 to 17, wherein monitoring for the control transmissions includes: monitoring for the control transmissions in accordance with the change to the control region until a timer expires.

Aspect 19 is a method of any of aspects 1 to 18, wherein monitoring for the control transmissions includes: monitoring for the control transmissions in accordance with the change to the control region until reception of a next message that changes the control region.

Aspect 20 is an apparatus for wireless communication at UE, comprising: at least one memory; and at least one processor coupled to the at least one memory, the at least one processor, individually or in any combination, is configured to perform the method of any of aspects 1 to 19.

Aspect 21 is an apparatus for wireless communication at a UE, comprising means for performing each step in the method of any of aspects 1 to 19.

Aspect 22 is the apparatus of any of aspects 1 to 19, further comprising a transceiver configured to receive or to transmit in association with the method of any of aspects 1 to 19.

Aspect 23 is a computer-readable medium (e.g., a non-transitory computer-readable medium) storing computer executable code at a UE, the code when executed by at least one processor causes the at least one processor to perform the method of any of aspects 1 to 19.

Aspect 24 is a method of wireless communication of a network node, comprising: transmitting a message that is common to multiple user equipment (UEs), wherein the message indicates a change to the control region that applies to one or more subsequent control transmission occasion; and transmitting a control transmission in accordance with the change to the control region indicated in the message.

Clause 25 is a method of clause 24, wherein the control region corresponds to time and frequency resources for a UE of the multiple UEs to monitor for the control transmissions.

Clause 26 is a method of any of aspects 23 to 25, wherein the change to the control region is a modification that applies to one or more active control regions for the UE.

Clause 27 is a method of any of aspects 23 to 26, wherein the at least one processor is further configured to: configure the UE to modify a duration of the control region for the one or more subsequent control transmission occasions based on the change to the control region indicated in the message.

Clause 28 is a method of any of aspects 23 to 27, wherein the message indicates an update to the duration of the control region as an absolute duration.

Clause 29 is a method of any of aspects 23 to 28, wherein the message indicates an update to the duration of the control region as a difference relative to a current duration of the control region.

Clause 30 is a method of any of aspects 23 to 29, wherein the at least one processor is further configured to: configure the UE to modify a current bandwidth of the control region to an updated bandwidth of the control region in accordance with the change in the control region indicated in the message.

Clause 31 is a method of any of aspects 23 to 30, wherein the change indicated to the control region includes an indication to switch to a different control region or a different control region configuration.

Clause 32 is a method of any of aspects 23 to 31, wherein the change to the control region includes an updated bandwidth indicated in the message by one or more of a control region identifier (ID) or an index that is different than the control region ID.

Aspect 33 is an apparatus for wireless communication at a network node, comprising: at least one memory; and at least one processor coupled to the at least one memory, the at least one processor, individually or in any combination, is configured to perform the method of any of aspects 23 to 32.

Aspect 34 is an apparatus for wireless communication at a network node, comprising means for performing each step in the method of any of aspects 23 to 32.

Aspect 35 is the apparatus of any of aspects 23 to 32, further comprising a transceiver configured to receive or to transmit in association with the method of any of aspects 23 to 32.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive, from a network node, a message common to multiple UEs that include the UE, wherein the message indicates a change to a control region that applies to one or more subsequent control transmission occasions; and
monitor for control transmissions in accordance with the change to the control region indicated in the message.

2. The apparatus of claim 1, wherein the control region corresponds to time and frequency resources for the UE to monitor for the control transmissions.

3. The apparatus of claim 1, wherein the change to the control region is a modification that applies to one or more active control regions for the UE.

4. The apparatus of claim 3, wherein the at least one processor is further configured to:
modify a duration of the control region for the one or more subsequent control transmission occasions based on the change to the control region indicated in the message.

5. The apparatus of claim 4, wherein the message indicates an update to the duration of the control region as an absolute duration.

6. The apparatus of claim 4, wherein the message indicates an update to the duration of the control region as a difference relative to a current duration of the control region.

7. The apparatus of claim 3, wherein the at least one processor is further configured to:
modify a current bandwidth of the control region to an updated bandwidth of the control region in accordance with the change in the control region indicated in the message.

8. The apparatus of claim 3, wherein the change indicated to the control region includes an indication to switch to a different control region or a different control region configuration.

9. The apparatus of claim 8, wherein the change to the control region includes an updated bandwidth indicated in the message by one or more of a control region identifier (ID) or an index that is different than the control region ID.

10. The apparatus of claim 8, wherein the indication to switch indicates at least one of:
a first switch from a current control region to an associated control region that is associated with the current control region, or
a second switch from a first configuration associated with the control region to a second configuration associated with the control region.

11. The apparatus of claim 1, wherein the message is indicated a broadcast transmission, wherein the message comprises at least one of:
a downlink control information (DCI) transmission;
a medium access control-control element (MAC-CE) in a physical downlink shared channel (PDSCH) transmission; or
a system information block (SIB) transmission.

12. The apparatus of claim 1, wherein the message is indicated in a groupcast transmission to the multiple UEs that include the UE, wherein the message comprises at least one of:
a group common downlink control information (DCI) transmission; or
a medium access control-control element (MAC-CE) in a multi-cast physical downlink shared channel (PDSCH) transmission.

13. The apparatus of claim 1, wherein the message indicates a radio network temporary identifier (RNTI) associated with control region changes, wherein the RNTI is common to a group of UEs, which includes the UE.

14. The apparatus of claim 1, wherein the message comprises one or more fields common to a group of UEs, which includes the UE, wherein the one or more fields indicate the change to the control region.

15. The apparatus of claim 1, wherein the message comprises a DCI that has a plurality of fields, wherein a subset of one or more fields indicates the change to the control region for the UE and other fields of the plurality of fields are for other UEs of the multiple UEs.

16. The apparatus of claim 15, wherein the at least one processor is further configured to:
determine the subset of one or more fields for the UE based on a configuration or a radio network temporary identifier (RNTI).

17. The apparatus of claim 1, wherein the at least one processor is further configured to:
exclude a set of one or more control regions from the change to the control region indicated in the message, wherein the set of one or more control regions is based on least on one of:
a rule that defines the one or more excluded control regions;
a configuration of one or more excluded control regions obtained prior to reception of the message that changes the control region; or
an indication of the one or more excluded control regions in the message that indicates the change.

18. The apparatus of claim 1, wherein to monitor for the control transmissions, the at least one processor is further configured to:
monitor for the control transmissions in accordance with the change to the control region until a timer expires.

19. The apparatus of claim 1, wherein to monitor for the control transmissions, the at least one processor is further configured to:
monitor for the control transmissions in accordance with the change to the control region until reception of a next message that changes the control region.

20. An apparatus for wireless communication at a network node, comprising:
at least one memory; and
at least one processor coupled to the at least one memory and, based at least in part on information stored in the at least one memory, the at least one processor is configured to:
transmit a message that is common to multiple user equipment (UEs), wherein the message indicates a change to a control region that applies to one or more subsequent control transmission occasions; and
transmit a control transmission in accordance with the change to the control region indicated in the message.

21. The apparatus of claim 20, wherein the control region corresponds to time and frequency resources for a UE of the multiple UEs to monitor for the control transmission.

22. The apparatus of claim 21, wherein the change to the control region is a modification that applies to one or more active control regions for the UE.

23. The apparatus of claim 22, wherein the at least one processor is further configured to:
configure the UE to modify a duration of the control region for the one or more subsequent control transmission occasions based on the change to the control region indicated in the message.

24. The apparatus of claim 23, wherein the message indicates an update to the duration of the control region as an absolute duration.

25. The apparatus of claim 23, wherein the message indicates an update to the duration of the control region as a difference relative to a current duration of the control region.

26. The apparatus of claim 22, wherein the at least one processor is further configured to:
configure the UE to modify a current bandwidth of the control region to an updated bandwidth of the control region in accordance with the change in the control region indicated in the message.

27. The apparatus of claim 22, wherein the change indicated to the control region includes an indication to switch to a different control region or a different control region configuration.

28. The apparatus of claim 27, wherein the change to the control region includes an updated bandwidth indicated in the message by one or more of a control region identifier (ID) or an index that is different than the control region ID.

29. A method of wireless communication of a user equipment (UE), comprising:
receiving, from a network node, a message common to multiple UEs including the UE for changing a control region, wherein the message indicates a change to the control region that applies to one or more subsequent control transmission occasions; and
monitoring for control transmissions in accordance with the change to the control region indicated in the message.

30. A method of wireless communication of a network node, comprising:
transmitting a message that is common to multiple user equipment (UEs), wherein the message indicates a change to a control region that applies to one or more subsequent control transmission occasion; and
transmitting a control transmission in accordance with the change to the control region indicated in the message.
